(19) United States
(12) Patent Application Publication
(10) Pub. No.: US 2026/0119055 A1
(43) Pub. Date: Apr. 30, 2026

(54) SLUMBER MODE FOR MEMORY TO REDUCE LEAKAGE IN ACTIVE MODE

(71) Applicant: Silicon Laboratories Inc., Austin, TX (US)

(72) Inventors: Thomas Saroshan David, Lakeway (TX); Paul Ivan Zavalney, Austin, TX (US); Eric Jonathan Deal, Austin, TX (US); Rejoy Roy Mathews, Austin, TX (US); Satyaprasad Nistala, Austin, TX (US)

(21) Appl. No.: 18/930,499

(22) Filed: Oct. 29, 2024

(51) Int. Cl. G06F 3/06

(52) U.S. Cl. CPC G06F 3/0625; G06F 3/0634; G06F 3/0673

(57) ABSTRACT

A technique dynamically configures a memory bank in a slumber state that maintains power to an array of bit cells but powers down periphery logic of the memory bank to reduce power consumption by an integrated circuit system in an active mode of operation. The memory bank includes periphery logic and an array of storage elements that are configured to receive power from different power domains and powers down the periphery circuits when the access frequency for the memory bank is below a predetermined access frequency. Slumber control logic determines whether the memory bank has been accessed in a previous interval defined by a predetermined number of clock cycles. If the memory bank has not been accessed in the previous interval, then the slumber control logic configures the memory bank in the slumber state.

### BACKGROUND

### Field of the Invention

This application is related to integrated circuits and more particularly to reducing power consumption of memory circuits.

### Description of the Related Art

In general, an integrated circuit system or Systems on Chip (SoC) that includes large memory circuits (e.g., at least one Mega-Byte of Random-Access Memory (RAM)) generate substantial leakage current, even during an active mode of operating the integrated circuit system. Accordingly, techniques for reducing leakage current in integrated circuit systems including memory circuits are desired.

### SUMMARY OF EMBODIMENTS OF THE INVENTION

In at least one embodiment, a method for reducing power consumption in an integrated circuit system includes entering a slumber state of a memory bank from an active state of the memory bank in response to the memory bank being inactive for a predetermined interval. In the slumber state, an array of storage elements of the memory bank is powered up and periphery logic of the memory bank is powered down. The memory bank may enter the slumber state from the active state in response to a chip select signal for the memory bank being inactive for the predetermined interval. Entering the slumber state may include disabling the periphery logic by powering down a first power domain. The array of storage elements may be powered up and receives power from a second power domain. The method may include maintaining the memory bank in the slumber state until the chip select signal for the memory bank transitions from an inactive level to an active level. The method may include entering a slumber exit state of the memory bank from the slumber state of the memory bank in response to a transition of the chip select signal for the memory bank from an inactive level to an active level. The method may include stalling a memory transaction corresponding to the transition of the chip select signal for the memory bank until the memory bank has entered the active state from the slumber exit state.

In at least one embodiment, a memory bank includes an array of storage elements and periphery logic configured to control the array of storage elements. The memory bank is configured to enter a slumber state from an active state in response to the memory bank being inactive for a predetermined interval. In the slumber state, the array of storage elements is powered up and the periphery logic is powered down. The memory bank may enter the slumber state from the active state in response to a chip select signal for the memory bank being inactive for the predetermined interval. The periphery logic may be coupled to a first power domain, and the array of storage elements may be coupled to a second power domain. The apparatus may include a slumber control circuit coupled to the memory bank and configured to generate a slumber control signal based on the chip select signal for the memory bank and a maximum count signal. The slumber control signal may be further based on a predetermined slumber wakeup period. The slumber control circuit may include a finite state machine configured to generate the slumber control signal, a periphery logic reset signal, and an extend wait signal. The finite state machine may configure the memory bank in the slumber state, an exit slumber state, or the active state based on the chip select signal for the memory bank and the maximum count signal. The finite state machine may be further responsive to a predetermined wakeup period.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of a memory system.

FIG. 2 illustrates a functional block diagram of a portion of the memory system of FIG. 1 consistent with at least one embodiment of the invention.

FIG. 3 illustrates a state diagram for a slumber finite state machine of FIG. 2 consistent with at least one embodiment of the invention.

FIG. 4A illustrates a timing diagram for entering a slumber state from an active state of a memory bank of FIG. 2 consistent with at least one embodiment of the invention.

FIG. 4B illustrates an alternative timing diagram for entering the slumber state from the active state of the memory bank of FIG. 2 consistent with at least one embodiment of the invention.

FIG. 5 illustrates a timing diagram of slumber FSM signals and RAM bank signals associated with exiting the slumber state and entering the active state of the memory bank of FIG. 2 consistent with at least one embodiment of the invention.

The use of the same reference symbols in different drawings indicates similar or identical items.

### DETAILED DESCRIPTION

A technique for reducing power consumption of an integrated circuit system operating in an active mode dynamically configures a memory bank in a slumber state that keeps an array of bit cells powered up but powers down periphery logic of the memory bank. While operating in the active mode of the integrated circuit system, slumber control logic powers down the periphery logic when the access frequency for the memory bank is below a predetermined frequency. The slumber control logic determines whether the memory bank has been accessed in a previous interval defined by a predetermined number of clock cycles. If the memory bank has not been accessed in the previous interval, then the slumber control logic configures the memory bank in the slumber state.

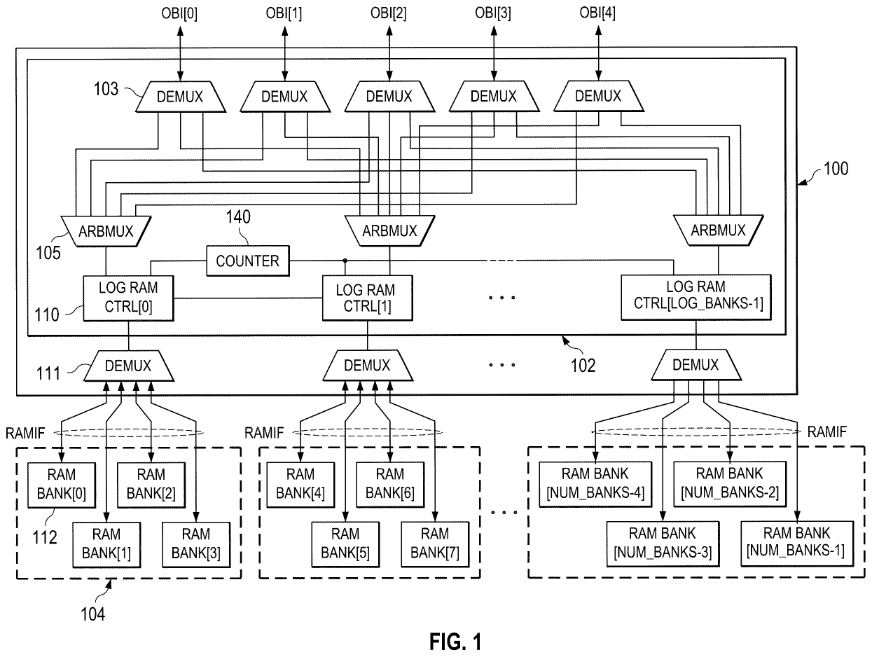

Referring to FIG. 1, a typical memory subsystem includes multiple RAM banks that are individually accessible by memory controller 100. As referred to herein, a RAM bank is a physical RAM bank or a logical RAM bank. A logical RAM bank includes multiple physical RAM banks that are grouped as a single entity for address mapping and arbitration by the memory controller to reduce area. A RAM bank includes an array of storage elements (e.g., bit-cells) and periphery logic that are configured to receive power from separate power domains, e.g., bit-cell array power supply node and periphery logic power supply node. The periphery logic includes high performance devices that have relatively high leakage currents. To reduce overall system current during an active mode of operation of the integrated circuit system, memory controller 100 powers down the periphery logic power domain when the integrated circuit system is idle (e.g., in a sleep mode of operation of the integrated circuit system) or when an individual RAM bank is idle (e.g., during the active mode of operation of the integrated circuit system).

In at least one embodiment, an integrated circuit system for a target application executes a localized memory access pattern that does not access a RAM bank for a substantial period making that RAM bank superfluous for that period. Thus, that RAM bank can be configured in the slumber state during the active mode (i.e., normal operation) of the integrated circuit system, thereby reducing leakage current during the active mode. While the RAM bank is in the slumber state, the integrated circuit system continues normal operation (e.g., a controller coupled to the memory system continues to execute firmware for a target application). If the RAM bank is configured in the slumber state and is accessed by the memory controller, a slumber control circuit stalls the memory access for a predetermined number of cycles (e.g., 3-4 cycles) to allow the RAM bank sufficient time to power up and reset the periphery logic before servicing the memory access.

In an embodiment, a memory subsystem includes memory controller 100 having fabric 102, which is coupled to multiple instantiations of a logical RAM bank (e.g., logical RAM bank 104). In an embodiment, each instantiation of a logical RAM bank includes multiple instantiations of physical RAM bank 112 (e.g., physical RAM bank[0], physical RAM bank[1], physical RAM bank[2], and physical RAM bank[3] of logical RAM bank 104). Fabric 102 routes data to and from an appropriate RAM bank and bus port (e.g., OBI[0], OBI[1], OBI[2], OBI[3], or OBI[4]) using demultiplexers (e.g., demultiplexer 103) and arbitration multiplexers (e.g., arbitration multiplexer 105). In an embodiment, one demultiplexer corresponds to each 32-bit bus port, and fabric 102 is configured to operate using 32-bit wide data paths. More specifically, fabric 102 is configured to operate using a width that is the smallest bus port width or smallest individually addressable memory width. Thus, if memory can only be accessed in 64-bit blocks and all of the bus ports are at least 64 bits wide, then fabric 102 operates using 64-bit wide data paths. Although in FIG. 1 fabric 102 uses 32-bit wide data paths and the bus ports utilize data channels having the same bit width, in other embodiments, memory controller 100 uses data paths and bus ports having different bit widths and memory controller 100 embodies techniques that translate between bus protocols used by memory controller 100 and bus protocols used elsewhere in an integrated circuit system.

In an embodiment, each demultiplexer determines the destination of a data transaction. For example, demultiplexer 103 has a number of outputs that corresponds to the number of logical RAM banks. Demultiplexer 103 routes a memory transaction from its respective bus port to an arbiter multiplexer associated with the destination logical RAM bank. Each logical RAM bank has a respective arbiter multiplexer, which receives transaction requests from various demultiplexers, and prioritizes these requests such that the highest priority request gains access to an appropriate logical RAM bank.

In at least one embodiment, RAM control logic is disposed between each arbiter multiplexer and its respective logical RAM bank. For example, logical RAM controller 110 generates timing signals used by corresponding logical RAM bank 104. In at least some embodiments, logical RAM controller 110 generates error correcting codes (ECC) for all data being written to the logical RAM bank 104 and ensures the validity of any data read from logical RAM bank 104 by verifying the ECC and performing any error corrections that are required. Each demultiplexer coupled between a RAM controller and a corresponding logical RAM bank routes a memory transaction from its respective RAM controller to a physical RAM bank associated with the memory transaction. In an embodiment fabric 102 uses a single bus protocol that is referred to as the fabric interconnect protocol. The fabric interconnect protocol may be Open Bus Interface (OBI), Advanced extensible Interface (AXI), Advanced High-Speed Bus (AHB), or other suitable interface. In an embodiment, fabric 102 utilizes the OBI protocol and the RAM interface between a demultiplexer (e.g., demultiplexer 111) and a physical RAM bank (e.g., physical RAM bank[0], physical RAM bank[1], physical RAM bank[2], and physical RAM bank[3] of logical RAM bank 104) includes a clock signal (CLK), a periphery logic reset signal (RESET), a RAM access enable (CE), a RAM write enable (WE), a RAM address (A), a RAM write data (WDATA), a RAM read data signal (Q), and a slumber state enable signal (SL). The memory subsystem of FIG. 1 is exemplary only and in other embodiments of an integrated circuit system consistent with the techniques described herein use a different memory controller structure, fabric, logical RAM bank structure, or RAM interface.

In at least one embodiment, fabric 102 includes counter 140 that is coupled to each RAM controller (e.g., RAM controller[0], RAM controller[1], . . . , RAM controller[LOG_BANKS−1], where LOG_BANKS is the number of logical RAM banks coupled to memory controller 100 and NUM_BANKS is the number of physical RAM banks coupled to memory controller 100). In other embodiments, counter 140 is excluded and each RAM controller includes a corresponding counter. In yet other embodiments, counter 140 is excluded from fabric 102 and a count function is provided by other hardware or by a general-purpose controller executing a loop in firmware that updates a stored count variable and accesses the count value from a register or other storage element. In at least one embodiment, counter 140 (or each local counter, as the case may be) has a predetermined maximum value and generates control signal MAX_CNT in response to the counter state being equal to a predetermined bank idle period count and has a predetermined range, e.g., 8 to 1024 clock cycles. If a RAM bank is idle for the entire duration of the predetermined bank idle period, then memory controller 100 configures the RAM bank in a slumber state and powers down the periphery logic of the RAM bank.

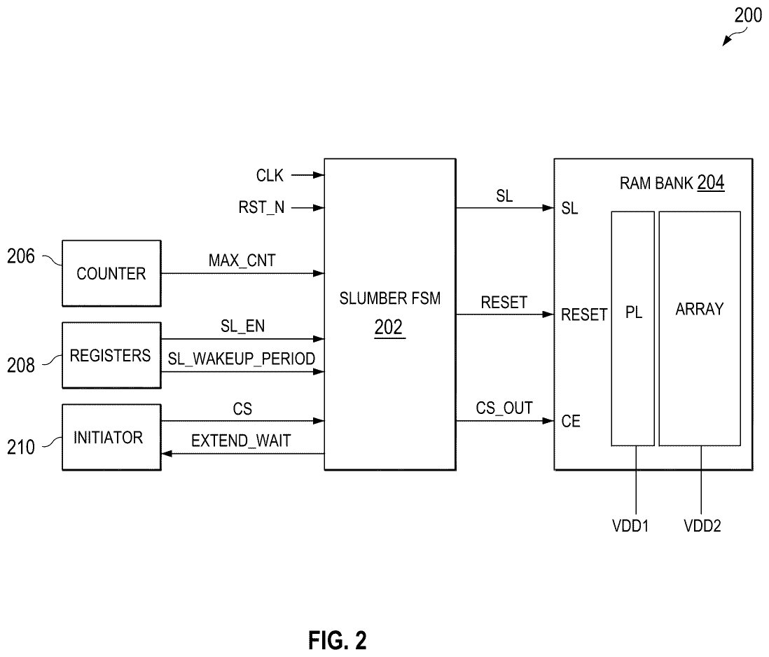

Referring to FIG. 2, in an embodiment, a memory controller includes slumber control logic having counter 206 (which may be a counter shared by various RAM controllers or a local counter included in a RAM controller, as described above), registers 208, and a slumber finite-state machine (slumber FSM) 202, which controls entering and exiting a slumber state by RAM bank 204. In at least one embodiment, counter 206 generates a maximum count signal (MAX_CNT) in response to counter 206 reaching a predetermined maximum count. The predetermined maximum count may be fixed (e.g., loaded to a configuration register in registers 208 from a one-time programmable storage element) or application-defined (e.g., loaded to the configuration register in registers 208 from pins, fuses, or firmware-defined values by firmware during system initialization). Counter 206 asserts a maximum count signal (MAX_CNT) (e.g., generates a pulse) in response to the maximum count value being reached before rolling over or resetting to a minimum count value.

In at least one embodiment, slumber FSM 202 is instantiated for each RAM bank in a memory subsystem. In at least one embodiment, counter 206 is a ten-bit, free-running counter and initiator 210 is a RAM controller in a memory controller, as described above. Initiator 210 is a bus master that generates the chip select signal (i.e., RAM access enable) in response to a memory transaction that accesses RAM bank 204. In an embodiment, registers 208 store predetermined values and state variables used by slumber FSM 202, as described further below.

In at least one embodiment, slumber FSM 202 receives a maximum count signal (MAX_CNT), a slumber feature enable signal (SL_EN), a slumber wakeup period signal (SL_WAKEUP_PERIOD), an input chip select signal (CS), a reset signal (RST_N), and a memory system clock signal (CLK). In an active integrated circuit system, slumber FSM 202 outputs a memory transaction stall signal (EXTEND_WAIT) to initiator 210 and a slumber state enable signal (SL), a periphery logic reset signal (RESET), and an output chip select signal (CS_OUT) for controlling RAM bank 204. In an embodiment, the memory system clock signal (CLK) and the reset signal (RST_N) are the same as a clock signal and reset signal (RST_N) provided to the memory controller. In an embodiment, the input chip select signal (CS) is generated by the memory controller during regular operation of the memory controller. The slumber feature enable signal (SL_EN) and the slumber wakeup period (SL_WAKEUP_PERIOD) are configuration signals that may be fixed (e.g., loaded to configuration registers in registers 208 from a one-time programmable storage element) or application-defined (e.g., loaded to configuration registers in registers 208 from pins, fuses, or firmware-defined values by firmware during system initialization). The slumber state enable signal (SL) controls the periphery logic power domain and selectively powers down the periphery logic to configure RAM bank 204 in a slumber state. Assertion of the periphery logic reset signal (RESET) causes RAM bank 204 to reset the periphery logic when causing RAM bank 204 to exit from the slumber state. Slumber FSM 202 de-asserts the output chip select signal (CS_OUT) when RAM bank 204 is in the slumber state and otherwise passes a version of the input chip select signal (CS) as the output chip select signal (CS_OUT). Although described in embodiments where counter 206, registers 208, and slumber FSM 202 are included in the memory controller, in other embodiments at least some of those circuits are external to the memory controller.

In an embodiment, RAM bank 204 is a physical RAM bank. In other embodiments, RAM bank 204 is a logical RAM bank and a distinct instantiation of slumber FSM 202 corresponds to each logical RAM bank 104 and each physical RAM bank in a logical RAM bank receives the same control signals (e.g., slumber state enable signal (SL), periphery logic reset signal (RESET), and output chip select signal (CS_OUT)) from the instantiation of slumber FSM 202. In an embodiment, RAM bank 204 includes at least one array of storage elements (e.g., bit cells) and corresponding periphery logic that controls the array (or arrays) of storage elements. The periphery logic is powered by a first power domain and the array of storage elements is powered by a second power domain. That is, the array of storage elements and the periphery logic receive power independently from each other and the array of storage elements can be powered up while the periphery logic is powered down. In an embodiment, each RAM bank receives separate power supply signals VDD1 and VDD2 coupled to the periphery logic and array logic, respectively, internally selectively powers down the periphery logic (e.g., by opening a switch coupling the periphery logic to VDD1) in response to the slumber state enable signal (SL), and the state of the array logic is unaffected by the slumber state enable signal (SL). In another embodiment, each RAM bank receives the same power supply signal VDD, but VDD is gated (e.g., by a switch coupling the periphery logic to VDD) to control power supplied to the periphery logic according to the slumber state enable signal (SL). In yet other embodiments, each RAM bank receives separate power supply signals VDD1 and VDD2 coupled to the periphery logic and array logic, respectively, and VDD1 is selectively powered down externally to the RAM bank (e.g., by opening a switch coupling VDD1 to the RAM bank) according to the slumber state enable signal. A memory controller includes an instantiation of slumber FSM 202 for each instantiation of RAM bank 204. The slumber FSM 202 can be instantiated across various subsystems of an integrated circuit system.

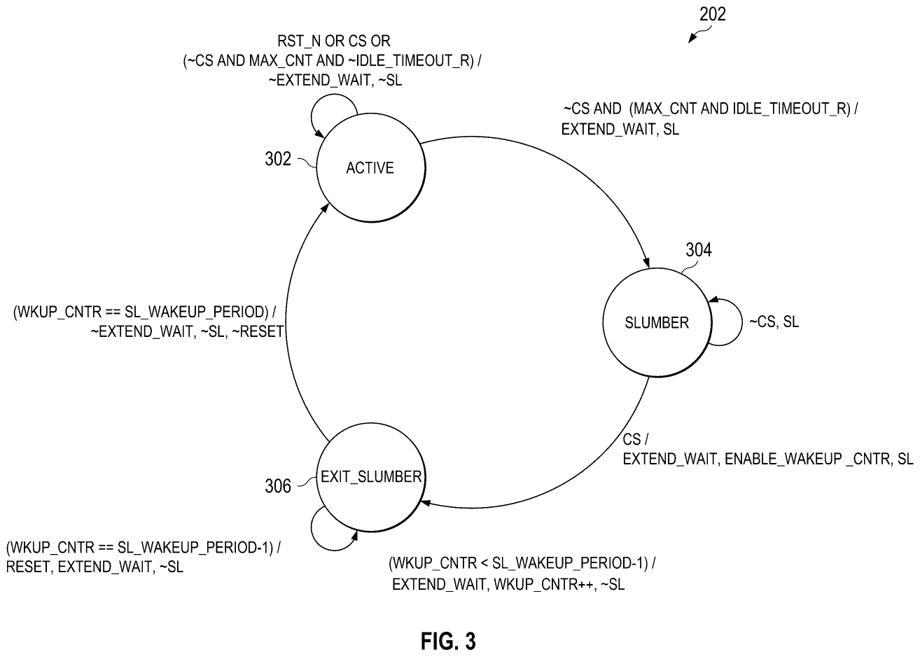

Referring to FIGS. 2 and 3, in at least one embodiment, slumber FSM 202 has three states: ACTIVE 302, SLUMBER 304, and EXIT_SLUMBER 306. In at least one embodiment, the current state of slumber FSM 202 is ACTIVE 302, which is the default state. If the reset signal is active (RST_N), input chip select signal is active (CS), or input chip select signal is inactive (˜CS), maximum count signal is active (MAX_CNT) (e.g., pulsed), and an idle timeout state variable is inactive (˜IDLE_TIMEOUT_R), then slumber FSM 202 passes the input chip select signal as the output chip select signal (CS_OUT=CS), passes the reset signal as the periphery logic reset signal (RESET=RST_N), de-asserts the slumber state enable signal (˜SL), de-asserts the memory transaction stall signal (˜EXTEND_WAIT), and the next state of slumber FSM 202 is ACTIVE 302.

If the input chip select signal is inactive (˜CS) and the maximum count signal (MAX_CNT) is active and the idle timeout state variable is asserted (IDLE_TIMEOUT_R), then slumber FSM 202 asserts the memory transaction stall signal (EXTEND_WAIT), asserts the slumber state enable signal (SL), and the next state of slumber FSM 202 is SLUMBER 304. In other embodiments, slumber FSM 202 asserts the memory transaction stall signal (EXTEND_WAIT) without driving the slumber state enable signal (SL) and the next state of slumber FSM 202 is SLUMBER 304.

If the current state of slumber FSM 202 is SLUMBER 304 and the input chip select signal is inactive (˜CS), then the state of slumber FSM 202 does not change, i.e., the next state is SLUMBER 304. If the current state of slumber FSM 202 is SLUMBER 304 and input chip select signal is active (CS), then slumber FSM 202 asserts the memory transaction stall signal (EXTEND_WAIT), enables an internal wakeup counter (ENABLE_WKUP_CNTR), asserts the slumber state enable signal (SL), and the next state of slumber FSM 202 is EXIT_SLUMBER 306.

If the current state of slumber FSM 202 is EXIT_SLUMBER 306 and the internal wakeup counter has a value that is less than the slumber wakeup period minus one cycle (WKUP_CNTR<SL_WAKEUP_PERIOD−1), then slumber FSM 202 asserts the memory transaction stall signal (EXTEND_WAIT), updates the wakeup counter (WKUP_CNTR++), de-asserts the slumber state enable signal (˜SL), and the next state of slumber FSM 202 is EXIT_SLUMBER 306. If the current state of slumber FSM 202 is EXIT_SLUMBER 306 and the internal wakeup counter has a value that is one cycle before the end of the slumber wakeup period (WKUP_CNTR==SL_WAKEUP_PERIOD−1), then slumber FSM 202 asserts the periphery logic reset signal (RESET), asserts the memory transaction stall signal (EXTEND_WAIT), de-asserts the slumber state enable signal (˜SL), and the next state of slumber FSM 202 is EXIT_SLUMBER 306. If the current state of slumber FSM 202 is EXIT_SLUMBER 306 and the internal wakeup counter has a value equal to the slumber wakeup period (WKUP_CNTR==SL_WAKEUP_PERIOD), then slumber FSM 202 de-asserts the periphery logic reset signal (˜RESET), de-asserts the memory transaction stall signal (˜EXTEND_WAIT), de-asserts slumber state enable signal (˜SL), and the next state of slumber FSM 202 is ACTIVE 302. In an embodiment, the wakeup counter returns to zero as slumber FSM 202 exits EXIT_SLUMBER 306. Although entry into, and exit from, the slumber state is dynamic and does not require software intervention, in at least one embodiment, software (e.g., firmware) executing on a controller coupled to the memory controller can bypass the slumber control logic or implement at least some of the functions of the slumber control logic and cause a RAM bank to enter into the slumber state from an active state or exit from the slumber state and return to the active state, as appropriate for a target application.

In an embodiment, when a RAM bank chip select signal is continuously inactive and slumber control logic samples two pulses of the maximum count control signal during this period, then the slumber control logic causes the corresponding RAM bank to enter the slumber state and asserts slumber state enable signal (SL). If a RAM bank is not accessed for a predetermined period (e.g., measured in a predetermined number of clock cycles), the slumber control logic determines when to cause the RAM bank to enter the slumber state by sampling the maximum count signal (MAX_CNT). The slumber control logic idles for a predetermined amount of time before asserting slumber state enable signal (SL).

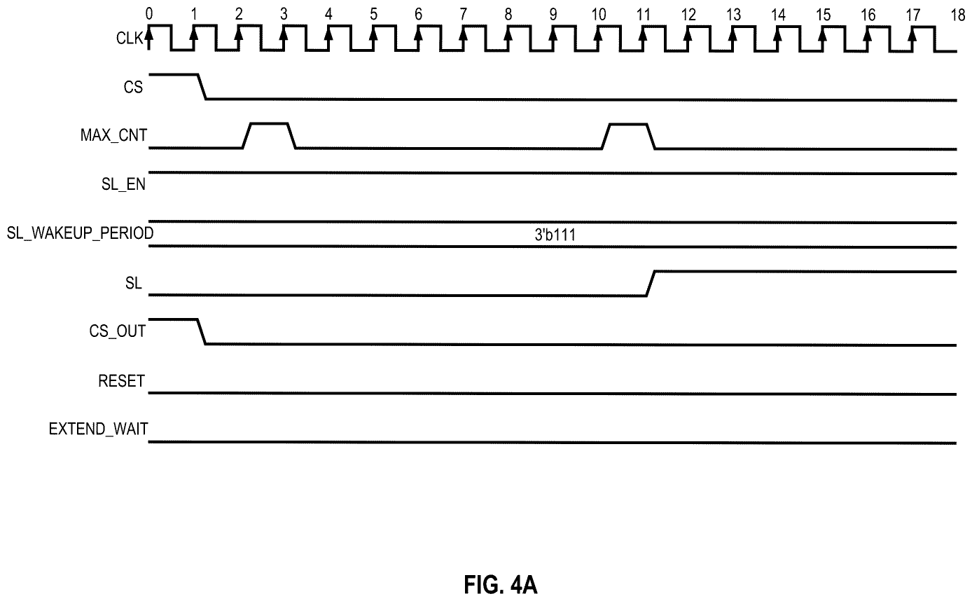

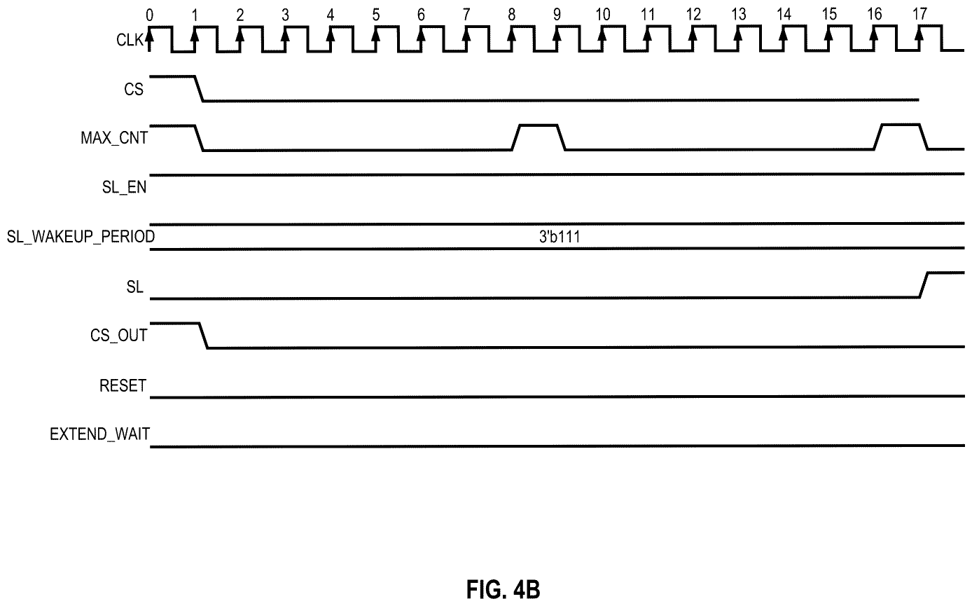

Referring to FIGS. 2, 4A, and 4B, the idle interval before entering the slumber state is determined by a number of clock cycles between de-assertion of the input chip select signal (˜CS) and the sampling of a second pulse of a maximum count signal (MAX_CNT). The idle interval is predetermined based on a maximum count signal (MAX_CNT). The number of clock cycles in the idle interval falls within a range of clock cycles based on the maximum count signal (MAX_CNT) and the relationship between when the input chip select signal (CS) becomes inactive with respect to the input chip select signal being de-asserted. For example, a free-running counter generates a periodic pulse on the maximum count signal (MAX_CNT) after reaching a maximum value (e.g., seven). The second pulse of the maximum count signal causes a transition to slumber state to occur between 8 and 15 clock cycles. That is, the idle time before entering the slumber state is not an exact value but falls within a range. In at least one embodiment, if a RAM bank is accessed during the time before entering the slumber state, then the internal idle timeout state variable resets (˜IDLE_TIMEOUT_R) and the periphery logic of the RAM bank is not powered down after the end of the current idle count period.

Referring to FIGS. 2 and 4A, in a first scenario, the input chip select signal and the output chip select signal are de-asserted (˜CS and ˜CS_OUT) during the second cycle of the memory system clock signal. A first pulse of the maximum count signal (MAX_CNT) occurs between the second and third cycle of the memory system clock signal. The slumber control logic described above does not assert the slumber state enable signal until a second pulse of the maximum count signal occurs and the idle period before entering the slumber state expires. A second pulse of maximum count signal (MAX_CNT) occurs between the tenth and eleventh cycle of the memory system clock signal. Referring to FIGS. 2 and 4B, in an alternate scenario, the input chip select signal and the output chip select signal (˜CS and ˜CS_OUT) are de-asserted during the second cycle of the memory system clock signal but the first pulse of the maximum count signal (MAX_CNT) occurs between the eighth and ninth cycle of the memory system clock signal. The slumber control logic does not assert the slumber state enable signal (SL) until it receives the second pulse of the maximum count signal (MAX_CNT) between the sixteenth and seventeenth cycle of the memory system clock signal.

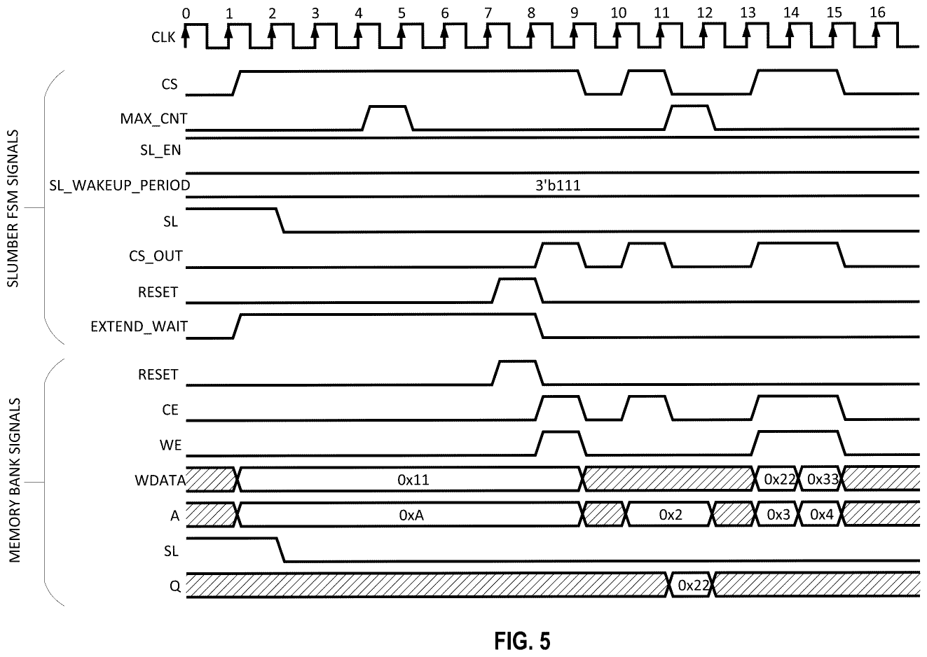

In general, a RAM bank requires a predetermined interval to wake up (e.g., power up and reset). After expiration of a power-up interval, the slumber control logic pulses periphery logic reset signal (RESET). Referring to FIGS. 2 and 5, in an embodiment, the slumber wakeup period (SL_WAKEUP_PERIOD) is seven cycles of the memory system clock signal, which includes six clock cycles for recovery from slumber mode and one clock cycle for reset of the periphery logic in the RAM bank. This interval may be fixed or programmable according to a RAM bank implementation. As described above, in at least one embodiment, exiting the slumber mode includes a transition state triggered by a transition of an input chip select signal from an inactive level (˜CS) to an active level (CS). Slumber FSM 202 acknowledges the transition of the chip select signal by asserting the memory transaction stall signal (EXTEND_WAIT) and enters a slumber exit transition state to prepare the RAM bank for the active mode. In at least one embodiment, the slumber state enable signal is de-asserted (˜SL). The memory transaction stall signal (EXTEND_WAIT) causes memory control logic to wait or hold a corresponding memory transaction during the transition from the slumber state to the active state.

In at least one embodiment, the wakeup time of the RAM from the slumber state to the active state is a predetermined interval and a number of cycles of a reference clock signal that correspond to that predetermined interval depends on the frequency of the reference clock signal. For example, if the wakeup time is 200 ns then the wakeup time takes four cycles of a 20 MHz reference clock signal and takes eight cycles of a 40 MHz reference clock signal. In at least one embodiment, the register corresponding to the wakeup time has a minimum value (e.g., three). A transition of the input chip select signal to an active level (CS) occurs at the first cycle of the memory system clock signal. The slumber control logic asserts the memory transaction stall signal (EXTEND_WAIT) and de-asserts the slumber state enable signal (˜SL). The assertion of the memory transaction stall signal (EXTEND_WAIT) causes a stall of the current memory transaction (e.g., WDATA and A of the RAM bank do not update). After six cycles of the memory system clock signal, the slumber control logic issues a pulse of the periphery logic reset signal (RESET). On the next cycle of the memory system clock signal, the slumber control logic de-asserts the memory transaction stall signal (˜EXTEND_WAIT) and passes the input chip select signal to the output chip select signal (CS_OUT=CS). Accordingly, RAM access enable (CE), a RAM write enable (WE) are passed to the RAM bank, and RAM write data (WDATA) and a RAM address (A) are updated for a next memory transaction. Note that the scenarios for entering the slumber state in FIGS. 4A and 4B and the scenario for exiting the slumber state of FIG. 5 are exemplary only and may vary with embodiments of the slumber control logic and frequency of the memory system clock signal.

Thus, techniques for reducing power consumption of an active integrated circuit system have been described. The description of the invention set forth herein is illustrative and is not intended to limit the scope of the invention as set forth in the following claims. The terms “first,” “second,” “third,” and so forth, as used in the claims, unless otherwise clear by context, are to distinguish between different items in the claims and do not otherwise indicate or imply any order in time, location or quality. For example, “a first received signal” and “a second received signal,” do not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for reducing power consumption in an integrated circuit system, the method comprising:
entering a slumber state of a memory bank from an active state of the memory bank in response to the memory bank being inactive for a predetermined interval,
wherein in the slumber state, an array of storage elements of the memory bank is powered up and periphery logic of the memory bank is powered down.

2. The method as recited in claim 1 wherein the memory bank enters the slumber state from the active state in response to a chip select signal for the memory bank being inactive for the predetermined interval and entering the slumber state comprises:
disabling the periphery logic by powering down a first power domain,
wherein the array of storage elements is powered up and receives power from a second power domain.

3. The method as recited in claim 1 further comprising:
maintaining the memory bank in the slumber state until a chip select signal for the memory bank transitions from an inactive level to an active level.

4. The method as recited in claim 1 further comprising:
entering a slumber exit state of the memory bank from the slumber state of the memory bank in response to a transition of a chip select signal for the memory bank from an inactive level to an active level.

5. The method as recited in claim 4 further comprising:
stalling a memory transaction corresponding to the transition of the chip select signal for the memory bank until the memory bank has entered or is ready to enter the active state from the slumber exit state.

6. The method as recited in claim 4 further comprising:
providing the chip select signal for the memory bank to a chip select terminal of the memory bank in the active state of the memory bank and de-asserting the chip select terminal of the memory bank in the slumber state of the memory bank.

7. The method as recited in claim 4 further comprising:
resetting the periphery logic of the memory bank and entering the active state of the memory bank from the slumber exit state of the memory bank in response to the active level of the chip select signal for the memory bank and expiration of a predetermined wakeup period.

8. The method as recited in claim 1 further comprising:
setting a maximum count of a counter to a predetermined value corresponding to the predetermined interval; and
generating a slumber enable signal based on the maximum count.

9. An apparatus comprising:
a memory bank comprising:
an array of storage elements; and
periphery logic configured to control the array of storage elements,
wherein the memory bank is configured to enter a slumber state from an active state in response to the memory bank being inactive for a predetermined interval,
wherein in the slumber state, the array of storage elements is powered up and the periphery logic is powered down.

10. The apparatus as recited in claim 9
wherein the memory bank enters the slumber state from the active state in response to a chip select signal for the memory bank being inactive for the predetermined interval,
wherein the periphery logic is coupled to a first power domain, and
wherein the array of storage elements is coupled to a second power domain.

11. The apparatus as recited in claim 9 further comprising:
a slumber control circuit coupled to the memory bank and configured to generate a slumber control signal based on a chip select signal for the memory bank and a maximum count signal.

12. The apparatus as recited in claim 11 wherein the slumber control signal is further based on a predetermined slumber wakeup period.

13. The apparatus as recited in claim 11 wherein the slumber control circuit comprises:
a finite state machine configured to generate the slumber control signal, a periphery logic reset signal, and an extend wait signal, the finite state machine configuring the memory bank in the slumber state, an exit slumber state, or the active state based on the chip select signal for the memory bank and the maximum count signal.

14. The apparatus as recited in claim 13 wherein the finite state machine is further responsive to a predetermined wakeup period.

15. The apparatus as recited in claim 13 wherein the finite state machine is further configured to provide the chip select signal for the memory bank to a chip select terminal of the memory bank in the active state of the memory bank and to de-assert the chip select terminal of the memory bank in the slumber state of the memory bank.

16. The apparatus as recited in claim 11 further comprising:
a counter configured to periodically update a count value,
wherein the maximum count signal is generated based on the count value.

17. The apparatus as recited in claim 16 further comprising:
a memory controller coupled to the memory bank, the memory controller comprising a routing fabric, wherein the slumber control circuit and the counter are included in the routing fabric.

18. The apparatus as recited in claim 11 further comprising:
an additional memory bank comprising:
an additional array of storage elements; and
additional periphery logic configured to control the additional array of storage elements; and
an additional slumber control circuit configured to generate an additional slumber control signal based on an additional chip select signal for the additional memory bank and the maximum count signal,
wherein the additional memory bank is configured to enter the slumber state from the active state in response to the additional memory bank being inactive for the predetermined interval.

19. An apparatus comprising:
a memory bank comprising:
an array of storage elements; and
periphery logic coupled to the array of storage elements; and
means for powering down the periphery logic and maintaining power to the array of storage elements in response to the memory bank being inactive for a predetermined interval.

20. The apparatus as recited in claim 19 further comprising:
a memory controller coupled to the memory bank, wherein the memory controller comprises the means for powering down the periphery logic.
